(19) United States
(12) Patent Application Publication
(10) Pub. No.: US 2025/0135505 A1
(43) Pub. Date: May 1, 2025

(54) CABLE CLEANER APPARATUS

(71) Applicant: Suncor Stainless Inc., Plymouth, MA (US)

(72) Inventors: James Storrer, Middleboro, MA (US); Patrick Striebel, Duxbury, MA (US); David Dion, Marion, MA (US)

(73) Assignee: Suncor Stainless Inc., Plymouth, MA (US)

(21) Appl. No.: 18/825,585

(22) Filed: Sep. 5, 2024

Related U.S. Application Data
(60) Provisional application No. 63/546,347, filed on Oct. 30, 2023.

(51) Int. Cl. B08B 1/40; B08B 1/12; B08B 1/30

(52) U.S. Cl. CPC B08B 1/40; B08B 1/12; B08B 1/30

(57) ABSTRACT

A hand-held cable cleaning apparatus. The apparatus has a body including an axial cavity extending along an axial length, the axial cavity is shaped to surround the cable. A cable slot extends a length of the axial cavity, the cable slot forming an opening between the axial cavity and an exterior of the body allowing the cable to enter the axial cavity through the cable slot. The apparatus can include a brush extending into the axial cavity for cleaning the cable. The apparatus can also include a fluid inlet port configured to direct fluid into a channel running axially through the body. A plurality of high-pressure tunnels extend between the channel and the axial cavity to direct fluid from the channel into the axial cavity.

### CROSS REFERENCE TO RELATED APPLICATIONS

This application claims priority to and the benefit of U.S. Provisional Patent Application No. 63/546,347, filed on Oct. 30, 2023, and entitled “CABLE CLEANER APPARATUS”, the contents of which are incorporated herein by reference as though fully set forth herein.

### FIELD OF THE TECHNOLOGY

The subject disclosure relates to cable cleaning methods and apparatus and more particularly relates to a handheld cable cleaning apparatus for cleaning wire-rope deck railing systems and method for cleaning cables of a deck railing system using a handheld apparatus.

### BACKGROUND OF THE TECHNOLOGY

Stainless steel wire-rope cables are used extensively in deck railing systems particularly in outdoor environments with exposure to weather, salt spray and pollution that builds up contaminants between the wire-rope strands causing corrosion and rust stains that are not aesthetically appealing. It is beneficial to regularly clean the cables in such systems to maintain a polished stainless-steel appearance.

Currently used wire rope cleaning methods that use spray chemicals and plastic bristle scrub brushes are labor intensive and do not clean the cables evenly. The plastic bristle brushes typically do not reach deep enough in the cable crevices to provide thorough cleaning. Other wire cleaning devices that are available on the market require cables to be temporarily detached or removed from their railing system in order to be insert through the cleaning device. Removal and reinstallation of the cables from their railing system for cleaning is labor intensive and requires re-tensioning all the cables in railing system.

Another currently used wire rope cleaning method utilizes a flexible plastic sleeve with an axial opening to fit over the cable. The sleeve wraps around the cable and is secured with a fastener such as a hook and loop (e.g. Velcro) fastener. Use of the fastener adds steps that can be time consuming especially when multiple wire sections must be cleaned. Moreover, fasteners such as hook and loop fasteners are susceptible to failure due to repetitive use and wear.

Some currently used wire rope cleaning devices are configured for connecting to a garden hose for cleaning and rinsing the cable. In presently available devices that include garden hose connections, ends of the cleaning devices are open, resulting in application of water pressure that is insufficient to thoroughly clean the wire crevices.

Other commercial wire rope cleaning devices are large and heavy and not suitable for onsite deck cleaning. Use of such devices for cleaning outside deck railing cables would also require the cables to be removed from their railing system for cleaning.

The presently available cable cleaning devices are inadequate for cleaning stainless steel wire-rope cables used in deck railing systems because they lack pressurized fluid flow and proper brush design to provide sufficient cleaning of cable surfaces and crevices. There is a need for an improved cable cleaning device with a combination of pressurized water and unique brushes to properly clean inside the wire crevices. There is a further need for such a device that easily slips onto the cable to be cleaned without removing cable from its deck railing system.

### SUMMARY OF THE TECHNOLOGY

The present disclosure describes a portable handheld wire rope cleaning device, or apparatus, that is specifically configured for ease of use and improved cleaning of deck cable railing systems. The disclosed devices include an improved combination of brushes and pressurized water to more easily remove dirt, contaminants and rust stains from a wire rope cable. The disclosed devices restore stainless steel cables to a clean polished appearance and improves cable durability and longevity.

In one example, the disclosed wire rope cleaning apparatus is a portable handheld assembly ideally suited for on-site cleaning applications. In an illustrative embodiment, grooves are provided on the outer surface of the wire rope cleaning apparatus to allow easy ergonomic hand gripping during use. A slot through the assembly permits quick and easy attachment and removal from the cable. An attachment on one end connects to a water supply typically with a garden hose. The water flows into the center chamber through a series of small tunnels to apply high pressure on the cable to remove particles. Wire brushes fitted in the center portion of the body clean deep inside the crevices between the wire strands. The pressurized water also disposes the particles out each end of the apparatus. The cable is easily and thoroughly cleaned by sliding the device back and forth along cable. In an illustrative embodiment, components of the disclosed device can be made from high density plastic which adds weight to improve the scrubbing action.

Two end caps retain a series of disks by four screws that clamp the assembly together to provide a watertight seal to maintain water pressure. The disks in the middle contain the wire brushes in a groove and slot. The elongated brushes fit into a hole for the hem and slot for brushes in the disks in the center body and are held captive by the end caps. Wire brush slots are designed to keep the brush bristles tight to prevent spreading. The tips of the bristles located near the center hole contact the cable and slide between the strands of the cable removing contaminants. The brush bristles can be fine stainless steel strands of wire to reach into small crevices. Alternatively, the bristles can be steel, or another material, depending on the type of cable intended to be cleaned. The bristles are intertwined to keep meshed so that the water pressure is concentrated on the wire cleaning, but not spraying outward on the user. This allows the apparatus to be rotated upside down and to avoid wetting the user and allow for cleaning at any angular rotation. In an illustrative embodiment stainless steel bristles are used to avoid further rust that can result from the use steel bristles. The bristles are aggressive enough to clean in the strands, but not impair the cable surface finish.

In an illustrative embodiment, the disclosed assembly is captivated with two ends, or end caps, held together by four screws. This permits case of assembly and disassembly for servicing or replacing brushes. In the illustrative embodiment, one end cap has counterbores for socket head cap screws. The end cap has the socket head cap screws inserted, and face upward.

In the illustrative embodiment, to assemble the disclosed apparatus, sections of the apparatus are placed over the four screws one at a time. After a first piece is in place, the wire brushes are inserted. Each section is placed on the socket head cap screws over the brushes until a final number of sections is placed on. Finally, the second end cap is placed over the four screws and the screws are tightened to make a watertight seal between the end caps and sections.

In an illustrative embodiment, the water inlet is an NPT pipe thread tapped hole to accept standard pipe fittings for various types of water connections. A garden hose is the typical connection. Other connections are possible such as barbed fitting to attach a hose to a water pump. The disclosed technology facilitates excellent cleaning to extend the life span of stainless-steel deck railing cables.

### BRIEF DESCRIPTION OF THE DRAWINGS

So that those having ordinary skill in the art to which the disclosed system pertains will more readily understand how to make and use the same, reference may be had to the following drawings.

FIG. 1 is a perspective view of a cable cleaning apparatus in accordance with the subject technology.

FIG. 2a is a cross-sectional side view of the cable cleaning apparatus of FIG. 1.

FIG. 2b is a perspective view, vertically cut, of the cable cleaning apparatus of FIG. 1.

FIG. 3 is an exploded view of the cable cleaning apparatus of FIG. 1.

FIG. 4 is a perspective view of a brush of the cable cleaning apparatus of FIG. 1.

FIG. 5 is a perspective view of a portion of the body of the cable cleaning apparatus of FIG. 1.

FIGS. 6a-6b are perspective views of a front end cap of the cable cleaning apparatus of FIG. 1.

FIG. 6c-6d are perspective views of a rear end cap of the cable cleaning apparatus of FIG. 1.

FIG. 7 is a side view of the cable cleaning apparatus of FIG. 1 when in use.

FIG. 8 is a perspective view of the cable cleaning apparatus of FIG. 1 when in use.

FIG. 9 is an exploded view of another embodiment of a cable cleaning apparatus in accordance with the subject technology, shown separated along a central vertical plane.

FIG. 10 is an exploded view of another embodiment of a cable cleaning apparatus in accordance with the subject technology.

FIG. 11 is a perspective view of another embodiment of a cable cleaning apparatus in accordance with the subject technology.

### DETAILED DESCRIPTION

The subject technology overcomes many of the prior art problems associated with devices for cleaning cable rails. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always at a higher elevation).

The present disclosure generally describes a wire cleaning brush system designed to clean cable railings of the type that are typically installed on exterior decks of residential and commercial structures. The apparatus slides along a length of cable and can clean the cable using internal brushes and pressurized water to reach debris in the cable crevices, as is discussed in more detail herein.

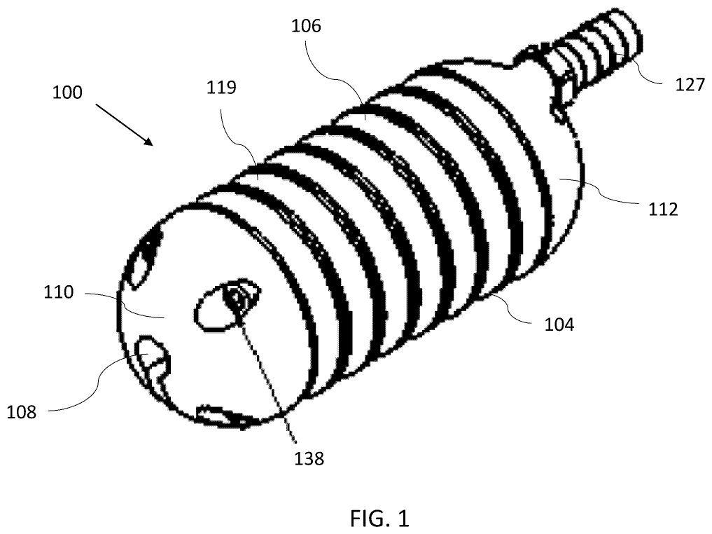

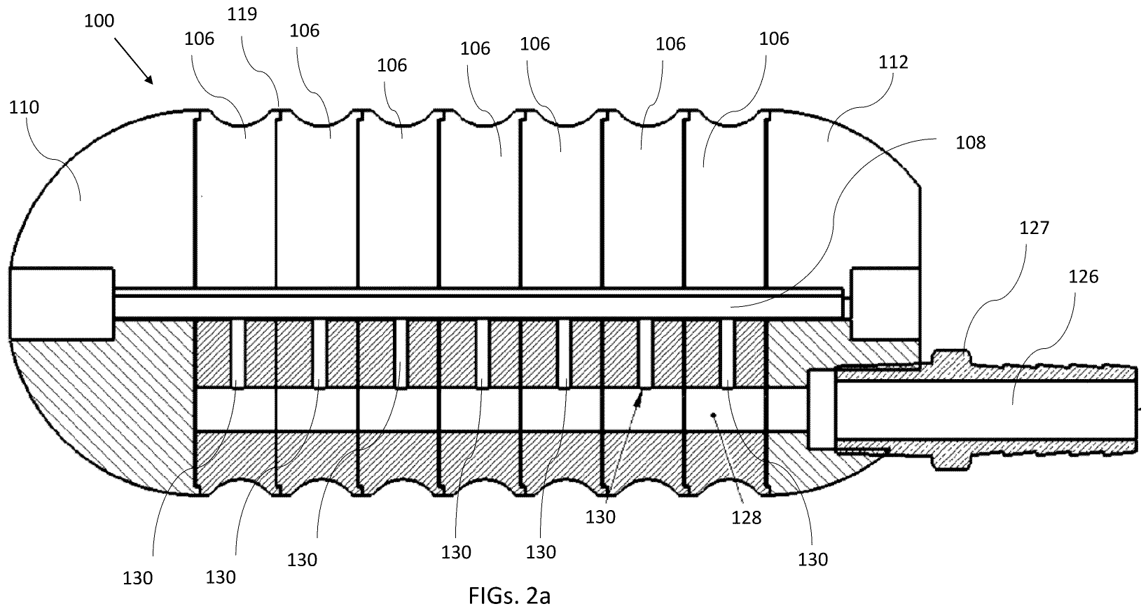

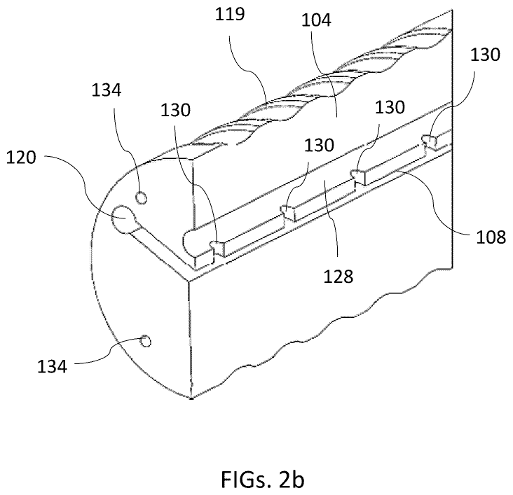

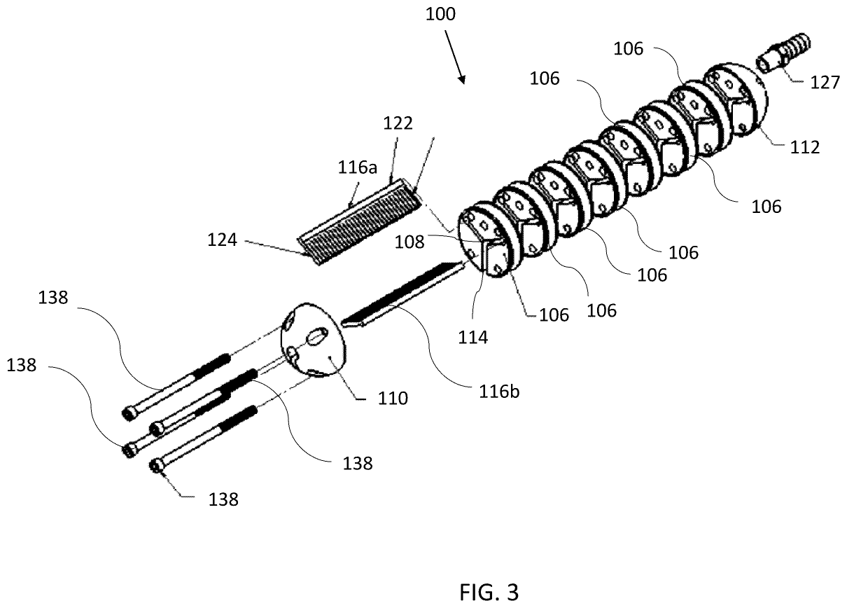

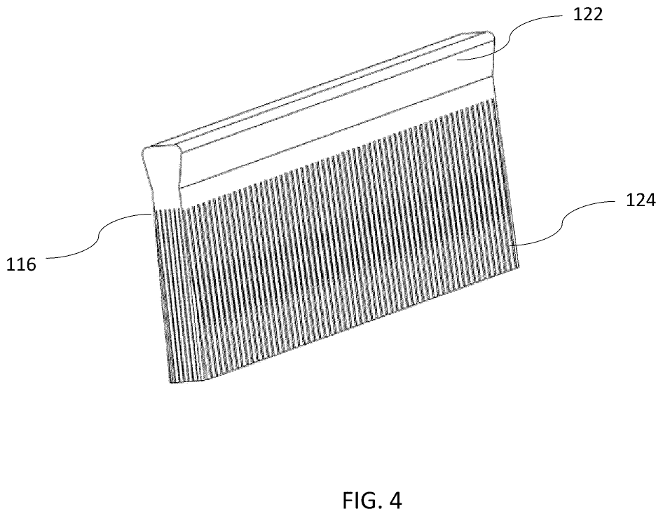

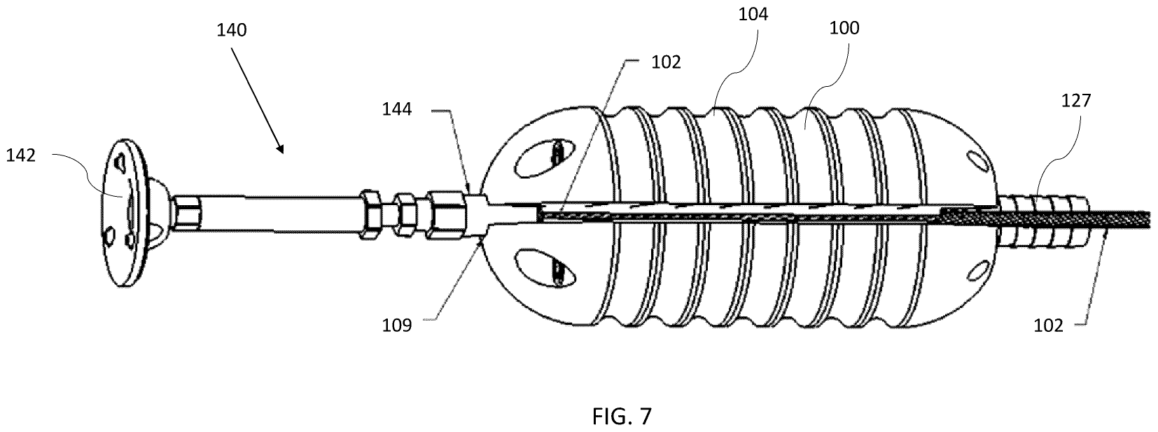

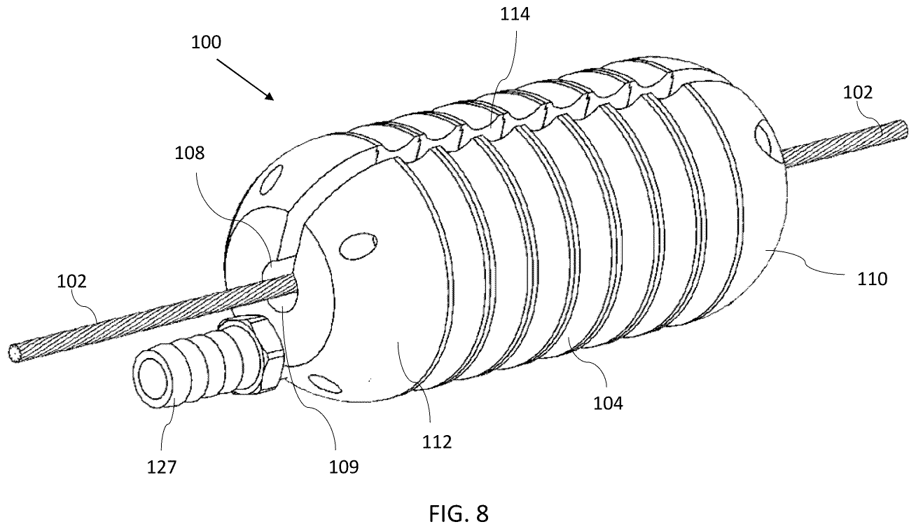

Referring now to FIGS. 1-8, a first embodiment of a cable cleaning apparatus in accordance with the subject technology is shown generally at 100. FIG. 1 shows a perspective view of the assembled apparatus 100. FIGS. 2a-2b show a vertical cross-sectional view of the apparatus 100, while FIG. 3 shows an exploded view of the apparatus 100. FIGS. 7-8 show the apparatus 100 in use, with a cable 102 positioned within the apparatus 100 for cleaning. FIGS. 4-6 are provided to show certain features of the apparatus 100, as discussed in more detail below.

The apparatus 100 is typically a material that is durable and waterproof. For example, the apparatus 100 can be a medium to high density plastic such as PVC to avoid scratching other surfaces or cause damage if dropped. In the exemplary apparatus 100, the body 104 is made up of a series of disks 106, which each have a corresponding shape and make up a cross-section of the body 104 (in other embodiments discussed herein, the body is a single, unitary component). Different total numbers of disks 106 can be incorporated into the body 104 to change the total length of the body 104 and apparatus 100 as may be desirable. Once the disks 106 are combined, the body 104 forms an axial cavity 108 across the length of the body 104, extending entirely between ends 110, 112 (shown half-sphere end caps 110, 112). The body 104 similarly defines a slot 114 extending from the axial cavity 108, through the perimeter 119 of the body 104 to the exterior. The slot 114 generally provides an opening through which a cable 102 can pass to enter the axial cavity 108 for cleaning. As such, both the slot 114 and axial cavity 108 can be sized and shaped according to the size of expected cables to be cleaned. In this example, the 0.200″ wide slot 114 for 5/32″ (0.156″) 1×19 cable provides. 0.044″ clearance to easily slip onto the cable. A similarly sized slot runs through all other components of the apparatus 100 (e.g. ends 110, 112) to allow the cable 102 to always reach the axial cavity 108.

The apparatus 100 generally cleans cables with a combination of one or more scrubbing devices, optionally in conjunction with the application of a high-pressure fluid. In the example shown, two brushes 116a, 116b (generally 116) are used for scrubbing the cable 102. The brush can have a stainless hem, at the distal end 122, holding in place a number of bristles 124 which extend to the proximal end. In some instances, the brush bristles 124 are 300 series stainless steel of about 0.004″ diameter to provide smooth scratch free cleaning without abrading the surface finish of the cable 102. The small diameter bristles 124 also clean in tight gaps between the strands on the wire cable 102. Alternative materials can also be used. For example, the brush bristles 124 can be steel, or another material used in conventional brushes, as are known, depending on the material of the cable intended for cleaning.

Each brush 116 can slide within, and be retained by, additional slots 118a, 118b (generally referred to herein as retention slots 118) which extend axially through the body 104. The retention slots 118 are oriented as a plane extending outwardly from the axial cavity 108, terminating within the body 104 before reaching the perimeter 119. The retention slots 118 each include a keyed end 120, distal to the axial cavity 108, which defines a larger opening through the body. The keyed ends 120 are used to secure the brushes 116. Accordingly, each brush 116 can include an enlarged distal end 122 which is sized and shaped to be retained within, and engaged by, the keyed end 120 of a retention slot 118. In the example shown, the enlarged distal ends 122 are angled outwardly, forming a trapezoidal shape which is wider than the retention slot 118. Different shapes of distal ends 122 and keyed ends 120 may also be used. Each distal end 122 slides axially through a keyed end 120 as the brush 116 is positioned within the respective retention the slot 118. Once the distal end 122 of each brush is fully seated within the respective keyed end 120 of the retention slot 118, the brush 116 is unable to move in any direction other than along the axial length of the body 104. The proximal end 124 of each brush 116 is held with its bristle end 124 within the axial cavity 108 to clean the cable 102.

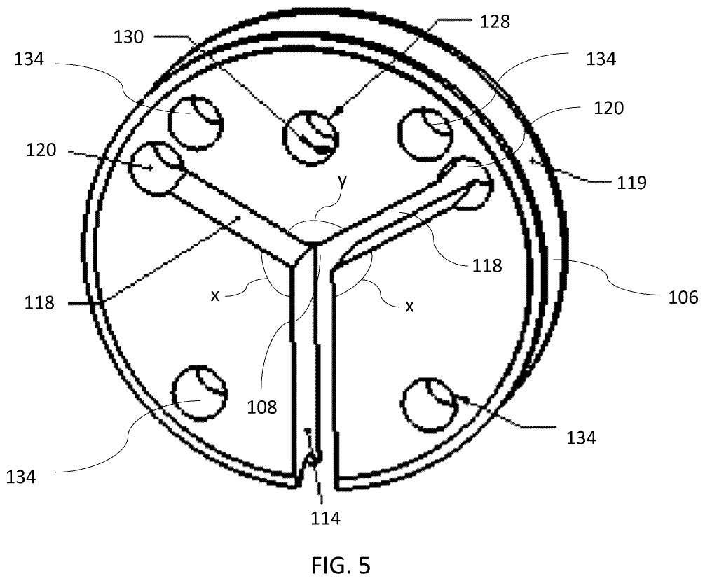

The retention slots 118 are generally angled with respect to the plane of the cable slot 114. As best seen in FIG. 5, in some instances, the retention slots 118 can be at an angle x of between 90-180 degrees with respect to the plane of the slot 114. In some cases, each retention slot 118 can be at an angle of between 110-130 degrees with respect to the slot 114. In some instances, there can be an angle y of between 110-130 degrees between the retention slots 118. In some instances, the angle x between each retention slot 118 and the cable slot 114 and the angle y between the retention slots 180 can be substantially equal, and can be substantially 120 degrees.

The apparatus 100 also uses a combination of an inlet port 126, channel 128, and high-pressure tunnels 130 to deliver pressurized fluid within the axial cavity 108 to clean the cable 102. The inlet port 126 is an NPT threaded hole providing an attachment for various standard pipe fittings to connect to the water source. To that end, a nozzle connection 127 can be threaded into the inlet port 126 to provide a hookup for a hose, elbow connection, or the like (other fittings can also be used). The inlet port 126 forms an opening through the exterior of the body 104 through which fluid can be delivered into the channel 128 within the body 104. The channel 128 runs axially through the body 104 offset from the axial cavity 108. In some instances, the channel 128 can run parallel to the to the axial cavity 108 through the entire length of the body 104. At a number of different locations, tunnels 130 extend between the channel 128 and the axial cavity 108. The tunnels 130 allow fluid from the channel 128 to flow into the axial cavity 108 to reach the cable 102. In some instances, each disk 106 of the body 104 includes one tunnel 130 between the channel 128 and the axial cavity 108. Similar tunnel spacing can be used in embodiments where the body 104 is a unitary structure.

The tunnels 130 form a series of small diameter passages, with a total cross-sectional area of the tunnels 130 being less than a cross-sectional area of the channel 128 (and less than the inlet port 126). This results in the fluid through the channel 128 becoming pressurized as it passes through the tunnels 130 and into the axial cavity 108. The high-pressure fluid then contacts the cable 102 at a higher velocity to assist the brushes 116 in dislodging debris from the cable 102. The fluid can then drain through one of the ends 110, 112 through an opening at the end of the axial cavity 108, along with any loose debris. Therefore the application of the high pressure fluid also helps avoid the build of debris within the axial cavity 108 created from the brushes 116 cleaning the cable 102 by draining through axial cavity 108.

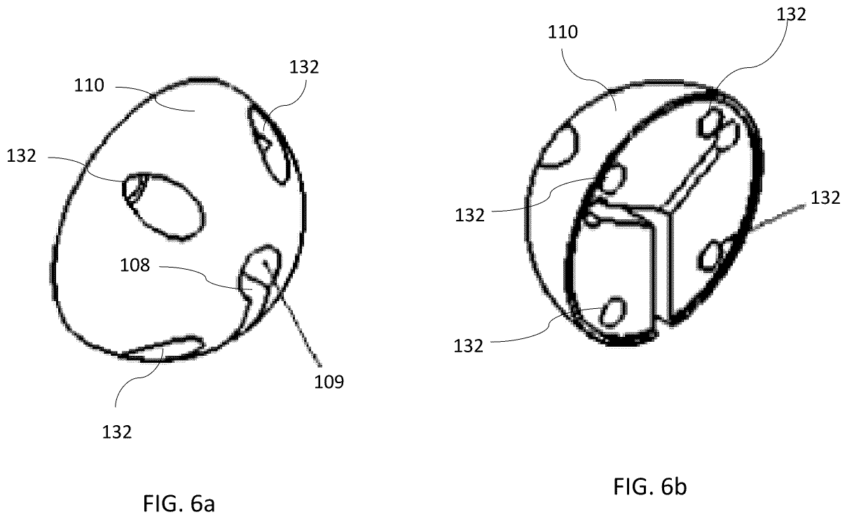

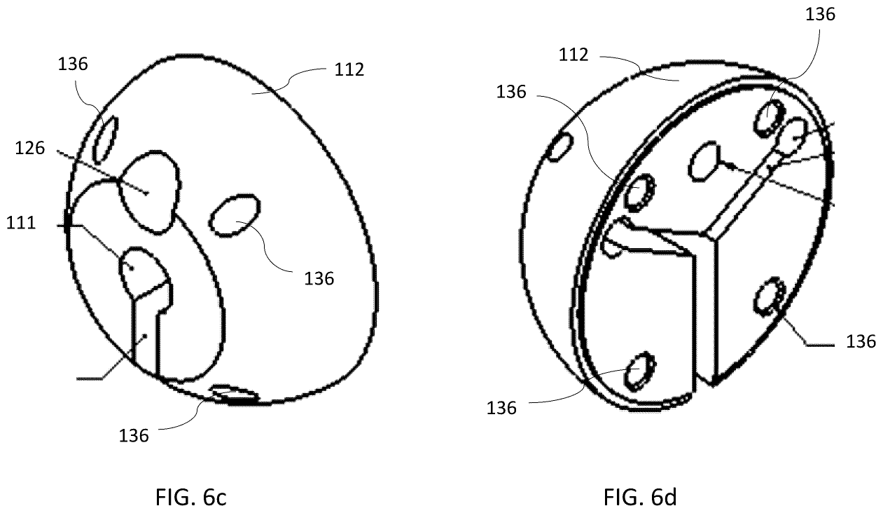

In some instances, the body 104 can be enclosed, on either end, by end caps 110, 112 (the end caps 110, 112 best seen in FIGS. 6a-6d). This arrangement is particularly helpful when the body 104 is made up of a series of disks 106, as with the apparatus 100, as the end caps 110, 112 can facilitate holding the disks 106 together. The first end cap 110 can be positioned on the first end of the body 104, and the second end cap 106 can be positioned on the second end of the body 104. The end caps 110, 112 and body 104 include a number of aligned holes 132, 134, 136 for screws 138 running through their entire length. In the embodiment shown, four screw holes 132, 134, 136 run axially through each of the end caps 110, 112 and body 104. Screws 138 can be threaded through the holes 132, 134, 136, fastening the end caps 110, 112, and body 104 together, and securing the entire apparatus 100.

The retention slots 118 can extend through the entire length of the body 104. If the brushes 116 are within the retention slots 118, fastening the end caps 110, 112 around the body 104 also secures the brushes 116 in the axial direction within the body 104. Further, the screws 138 can be easily unscrewed to replace the brushes 116 or clean out the interior of the body 104. In other examples, other known means for removably fastening mechanical components may be used instead of screws 138, as would be understood by one of skill in the art.

Referring now to FIGS. 7-8, an exemplary operation of the apparatus 100 is shown. The apparatus 100 is being used to clean a cable 102. The cable 102 is affixed within a typical cable rail system, as is known in the art. The cable rail system uses fasteners 140 to hold the cable 102 in place. The fasteners 140 include a first end 142 which is designed to couple to a structure (not shown), by screws or the like. A second end 144 of the fastener 140 is designed to grip the cable 102. The cable 102 can run between two such fasteners 140 which maintain a tension on the cable 102 between structures. A number of similar cables can run adjacent to one another to form a cable railing between the structures. These can be used, for example, as a balcony wall or along a set of stairs.

The apparatus 100 is initially moved over the cable 102 so the cable 102 enters the slot 114. The slot 114 is pushed over the cable 102 until the cable 102 enters the axial cavity 108 for cleaning. In this way, the apparatus 100 is designed to engage the cable 102 for cleaning with a simple movement, and without requiring any assembly. When the cable 102 is within the axial cavity 108, bristles 124 from the brushes 116 will contact the cable 102. Moving the apparatus 100 along the length of the cable 102 will therefore create friction between the brushes 116 and the cable 102, cleaning debris from the cable 102. Similarly, when the apparatus 100 is connected to a fluid source, the high-pressure tunnels 130 will direct fluid at the cable 102 to clean in different locations. Moving the apparatus 100 along the length of the cable 102 will cause the high-pressure fluid to strike the cable 102 along its entire length, cleaning the cable 102 and also helping to flush debris out of the axial cavity 108 of the body 104. The apparatus 100 can also be turned as it is moved along the cable to ensure all sides of the cable 102 are cleaned. The exterior of the disks 106 form an exterior gripping surface that can easily be gripped by a user's hand to allow the apparatus to be maneuvered. To that end, each disk 106 can have a concave exterior roughly corresponding to the size of an average human finger. The ends 110, 112 can also include a counterbore 109, 111 (respectively) which allow the ends 110, 112 to fit over a cable terminal end fitting of a cable rail system so that brushes 116 clean all the way up to the fastener ends 144.

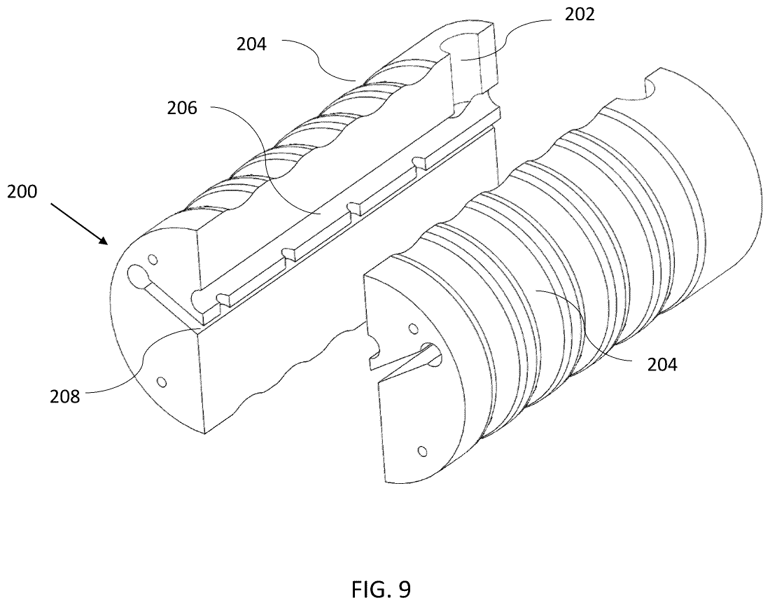

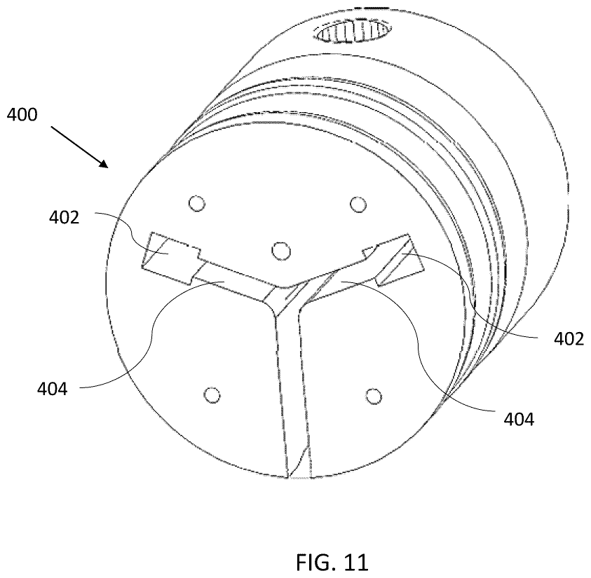

While the apparatus 100 is believed to be an effective cleaning tool, it should be understood that certain features may be changed, in other embodiments. Referring now to FIGS. 9-11, additional embodiments of cleaning apparatus 200, 300, 400 are shown, designed in accordance with the subject disclosure. These apparatus 200, 300, 300 can be similar to the cleaning apparatus 100, and other embodiments discussed herein, except as otherwise shown and described.

Referring now to FIG. 9, a view of another embodiment of an apparatus 200 is shown, with the apparatus 200 shown split vertically along a center plane for ease of viewing. The apparatus 200 includes many similar features to the apparatus 100. One difference, is that the fluid inlet 202 runs vertically (perpendicular to the axial cavity 208) between the exterior of the body 204 and the fluid channel 206. The fluid inlet 202 also passed directly through the body 204, rather than an end cap. This stands in contrast to the fluid inlet 126 of the apparatus 100, which runs parallel to the axial cavity 108 and generally through one of the end caps (e.g. end cap 112). Further, the apparatus 200 can include a body 204 formed from a single, unitary piece, similar to the apparatus 300 discussed below.

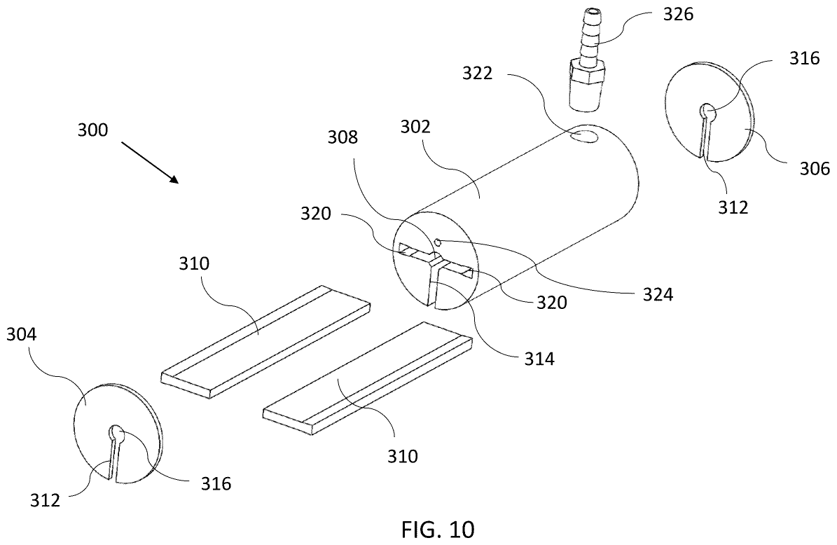

Referring now to FIG. 10, an exploded view is shown of an apparatus 300 where the entire body 302 is a single, unitary piece, rather than a plurality of disks. In such a case, the body 302 of the apparatus 300 can be formed by a single molding. This provides a simplified apparatus 300, which does not require the assembly of multiple parts (e.g. disks 106) to form the body 302.

The apparatus 300 also includes simplified ends, 304, 306, which can be flat, circular, disks. Like other embodiments herein, the ends 304, 306 can be fastened to either end of the body 302, to retain brushes 310 within the body 302. Each end 304, 306 generally includes a slot 312, corresponding to the cable slot 314 into the body 302, and a center bore 316 corresponding to the axial cavity 308 within the body 302. This allows a cable 102 to enter the axial cavity 308 through the slot 314.

The apparatus 300 also uses a slightly modified combination of retention slots 320 and brushes 310, as compared to the apparatus 100. The retention slots 320 combine to form a plane which runs perpendicular to the plane of the cable slot 314, intersecting at the axial bore 308. Therefore the brushes 310 are generally seated on opposite sides of the axial cavity 308, and contact any cable within the cavity 308 from opposite sides.

The apparatus 300 also utilizes a vertical inlet 322 through the body to direct fluid into the axial fluid channel 324 through the body 304. As with other embodiments herein, a nozzle 326 can couple to the vertical inlet 322 to provide a convenient connection for a hose, or other fluid source. Fluid in the channel 324 is directed into the axial cavity 308 by high pressure tunnels, as discussed within respect to the apparatus 100.

Referring now to FIG. 10, an additional embodiment is shown of an apparatus 400. The apparatus 400 is somewhat compressed, as compared to other embodiments herein. However, it should be understood that all examples may comprise different overall lengths and sizes, as may be desired. An additional distinction of apparatus 400 can be seen in the keyed ends 402 of the retention slots 404. The keyed ends 402 are formed, generally as a four sided polygon (i.e. a rectangle) with a width greater than a width of the retention slot. Thus, brushes used within the apparatus 400 may likewise include an enlarged distal end of a greater width than the retention slot 404 such that the enlarged end is secured within a respective keyed end 402 when in use.

As such, the various cable cleaning apparatus provide an easy and effective solution for cleaning wire rope cables. The apparatuses described herein effectively remove contaminants from cable crevices and clean cables as they are moved along the length of the cable. The portable handheld apparatus is economical and ideal for on-site applications.

All references cited herein are incorporated by reference, as though fully set forth herein. All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A cable cleaning apparatus for cleaning a cable, comprising:
a body including an axial cavity extending along an axial length of the body, the axial cavity extending between a first end and a second end opposite the first end, the axial cavity shaped to surround the cable;
a cable slot extending a length of the axial cavity, the cable slot forming an opening between the axial cavity and an exterior of the body, allowing the cable to enter the axial cavity through the cable slot;
at least one brush having a distal end configured to couple to the body and a proximal end configured to extend into the axial cavity; and
a fluid inlet port configured to direct fluid into a channel running axially through the body, wherein a plurality of high-pressure tunnels extend between the channel and the axial cavity to direct fluid from the channel into the axial cavity.

2. The cable cleaning apparatus of claim 1, wherein the body is made up of a at least two disks forming a cross section along the axial length of the body.

3. The cable cleaning apparatus of claim 2, wherein:
a first end cap is attached on the first end of the body;
a second end cap is attached on the second end of the body; and
a plurality of screws run through respective holes in the first end cap, the second end cap, and the body each to retain the body between the first end cap and the second end cap.

4. The cable cleaning apparatus of claim 1, wherein the body is a single, unitary piece.

5. The cable cleaning apparatus of claim 1, wherein the at least one brush includes two or more brushes.

6. The cable cleaning apparatus of claim 1, wherein the high-pressure tunnels comprise a total cross-sectional area less than a cross-sectional area of the channel, such that fluid through the channel is pressurized when passing through the high-pressure tunnels.

7. The cable cleaning apparatus of claim 1, wherein each brush is positioned within a retention slot, each retention slot extending axially along the axial cavity and forming a plane extending outwardly from the axial cavity.

8. The cable cleaning apparatus of claim 7, wherein each retention slot includes a keyed end distal to the axial cavity, the keyed end defining an enlarged opening within the body; and
each brush includes an enlarged distal end, sized and shaped for retention within the keyed end, wherein when the enlarged distal end of the brush is positioned within the keyed end of the retention slot, the brush is unable to move in any direction other than along the axial length of the body.

9. The cable cleaning apparatus of claim 8, wherein each brush includes bristles at a proximal end of the brush, the bristles positioned within the axial cavity to engage the cable when the cable is within the axial cavity.

10. The cable cleaning apparatus of claim 7, wherein each retention slot is at an angle of between 90 and 180 degrees with respect to the cable slot.

11. The cable cleaning apparatus of claim 2, wherein each disk has a concave exterior surface generally corresponding to the size of a human finger.

12. The cable cleaning apparatus of claim 1, wherein the channel runs parallel to the axial cavity.

13. The cable cleaning apparatus of claim 1, wherein the fluid inlet port is threaded to couple to a nozzle, the nozzle configured to couple to a hose and form a fluid connection between the hose and the fluid inlet port.

14. A cable cleaning apparatus for cleaning a cable, comprising:
a body extending along an axial length between a first end and a second end opposite the first end, wherein the body defines:
an axial cavity along the axial length of the body, the axial cavity extending between the first and second ends of the body;
a cable slot extending a length of the axial cavity, the cable slot forming an opening between the axial cavity and an exterior of the body, allowing the cable to enter the axial cavity through the cable slot;
a retention slot extending axially along the axial cavity, the retention slot forming a plane extending outwardly from the axial cavity and terminating before reaching a perimeter of the body, wherein the retention slot includes a keyed end distal to the axial cavity, the keyed end defining an enlarged opening within the body; and
a channel running parallel to the axial cavity, at least one tunnel forming a fluid connection between the channel and the axial cavity.

15. The cable cleaning apparatus of claim 14, wherein the retention slot is at an angle of between 90 and 180 degrees with respect to the cable slot.

16. The cable cleaning apparatus of claim 15, further comprising a second retention slot extending axially along the axial cavity, the second retention slot forming a plane extending outwardly from the axial cavity and terminating before reaching the perimeter of the body, wherein the second retention slot includes a second keyed end distal to the axial cavity, the second keyed end defining a second enlarged opening within the body, wherein the second retention slot is at an angle of between 90 degrees and 180 degrees with respect to the cable slot.

17. The cable cleaning apparatus of claim 16, wherein the first retention slot and the second retention slot are each perpendicular to the cable slot.

18. The cable cleaning apparatus of claim 16, further comprising:
a first brush coupled within the retention slot, wherein the first brush includes a first enlarged distal end within the first keyed end; and
a second brush coupled within the second retention slot, wherein the second brush includes a second enlarged distal end within the second keyed end.

19. The cable cleaning apparatus of claim 14, wherein the retention slot extends through the first end of the body.

20. The cable cleaning apparatus of claim 14, further comprising a first end cap configured to connect to the body at the first end to enclose the retention slot, the first end cap including a cap slot therethrough, corresponding in shape and positioning to the cable slot of the body.
